(19) United States
(12) Patent Application Publication
(10) Pub. No.: US 2021/0383963 A1
(43) Pub. Date: Dec. 9, 2021

(54) IGNITION COIL

(71) Applicant: YURA TECH CO., LTD., Sejong (KR)

(72) Inventors: Yang Jun KIM, Hwaseong-si, Gyeonggi-do (KR); Jong Hyung LEE, Cheongju-si, Chungcheongbuk-do (KR); Moo Hyuk BANG, Daejeon (KR); Jae Moon JUNG, Asan-si, Chungcheongnam-do (KR)

(73) Assignee: YURA TECH CO., LTD., Sejong (KR)

(21) Appl. No.: 17/285,334

(22) PCT Filed: Nov. 29, 2019
(86) PCT No.: PCT/KR2019/016735

§ 371 Date: Apr. 14, 2021

(30) Foreign Application Priority Data
Dec. 7, 2018 (KR) 10-2018-0157304

(51) Int. Cl. H01F 38/12; F02P 3/02; H01F 5/00

(52) U.S. Cl. CPC H01F 38/12; H01F 2038/122; H01F 5/00; F02P 3/02

(57) ABSTRACT

The present invention provides an ignition coil which can be reduced in weight and cost while retaining the performance of conventional ignition coils. The objective of the present invention is to provide an ignition coil which can be manufactured using conventional processes, such that costs due to process switching are not incurred. The ignition coil is characterized by comprising: a pipe-shaped spool; and a wire wound on the outer circumference of the spool, wherein the wire is formed extending in one direction, and the central portion of a cross-section perpendicular to the direction of extension is formed of aluminum, while the outer surface of the cross-section is formed of copper.

### TECHNICAL FIELD

The present invention relates to an ignition coil for generating a spark of a spark plug and, more specifically, to an ignition coil that boosts a voltage on a battery side by using a wire winding ratio.

### BACKGROUND ART

Ignition coils are induction coils which generate sparks of spark plugs in a storage battery-type ignition device as one type of transformers, and the ignition coils are also referred to as spark coils. Such an ignition device is installed between a battery and a spark plug, and a conductive wire is primarily and secondarily wound on an iron core several hundreds to several thousands of times to make a coil. A low voltage input from the battery is boosted to a high voltage that a user want by using a primary and secondary winding ratio and is then supplied to the spark plug. Subsequently, insulation is achieved by filling the inside of the iron core with pitch or oil, and thus a voltage boost condition of the ignition coil is satisfied.

Meanwhile, as described in Patent Document 1 below, a copper (Cu) wire having low resistance and excellent conductive characteristics is used as the conductive wire of the ignition coil. However, the copper is characterized by high specific gravity, and thus the copper wire causes a reduction in fuel efficiency when used for an internal-combustion engine such as an automobile. In addition, the copper has a disadvantage that the cost per unit is high, which causes a decrease in competitiveness.

Therefore, research on a way to reduce the weight and cost while retaining the performance of the ignition coil has been conducted constantly in this technical field.

Also, when the copper wire is used as in the conventional art, there was a problem in that a heat-generating temperature of the copper is low because the heat-generating characteristics thereof is poor. In order to solve this problem, when winding a wire in a plurality of layers on a spool, it is common to widen the surface by making the number of windings on an upper layer less than that on a lower layer so that heat is appropriately dissipated. However, this method has a problem in that a process loss occurs because the number of windings has to be considered for each of winding layers of the wire.

### DISCLOSURE OF THE INVENTION

### Technical Problem

To solve the problem in the conventional art as described above, a specific object of the present invention is to provide an ignition coil which can be reduced in weight and cost while retaining the performance of conventional ignition coils. Furthermore, an object of the present invention is to provide an ignition coil, wherein since conventional processes can be used as they are when an improved ignition coil is manufactured, costs due to process switching are not incurred.

### Technical Solution

An embodiment of the present invention provides a following ignition coil so as to solve the problem described above. An ignition coil of the present invention comprises: a spool having a pipe shape; and a wire wound on an outer circumference of the spool, wherein the wire is formed extending in one direction, and a central portion of a cross-section perpendicular to the direction of extension is formed of aluminum, while an outer surface thereof is formed of copper.

Also, in the wire of present invention, a volume ratio of the aluminum is greater than 80% and less than 95%.

Also, in the wire of the present invention, a weight ratio of the aluminum in the wire is greater than 55% and less than 85%.

Also, the wire is wound on the spool so as to form a plurality of winding layers, and an uppermost layer positioned on an outermost side among the plurality of winding layers is formed having the same number of windings as a layer adjacent to the uppermost layer.

Furthermore, the winding layers are formed of at least three layers, and the numbers of windings are the same for each of the winding layers.

### Advantageous Effects

As described above, various effects including the following matters may be expected according to the technical solution of the present invention. However, the present invention does not need to exhibit all the following effects.

According to the present invention, as the wire made of the aluminum and the copper is used, the weight and cost can be reduced compared to the conventional one. Furthermore, as the weight is reduced, there is an effect of increasing fuel efficiency when utilized as a component of an internal-combustion engine. Particularly, there is an effect in which the weight is decreased by about 50% and the cost of raw material is reduced by about 30% when the aluminum has a weight ratio of 85%, compared to when 100% copper is used. Furthermore, there is an advantage in that heat-generating characteristics are excellent while retaining most of the performance of conventional ignition coils.

Also, the present invention is very economical in that since facilities relating to the conventional spools and wires can be used as they are, costs required for facility switching are not incurred even though a wire design is changed.

In addition, the present invention has an advantage in that since the numbers of windings of the wire are the same for each of winding layers, a process loss occurring by considering the number of windings for each of conventional winding layers can be reduced.

### BRIEF DESCRIPTION OF THE DRAWINGS

FIG. 1 is a perspective view of an ignition coil of the present invention.

FIG. 2 is a front view of FIG. 1.

FIG. 3 is a cross-sectional view illustrating a wire of an ignition coil of the present invention.

FIG. 4 is a partial cross-sectional view of FIG. 2 for explaining a wire structure.

FIG. 5 is a graph in which characteristics relating to energy are compared between the conventional art and the present invention.

FIG. 6 is a graph in which heat-generating characteristics are compared between the conventional art and the present invention.

### MODE FOR CARRYING OUT THE INVENTION

Hereinafter, specific embodiments will be described in detail with reference to the drawings.

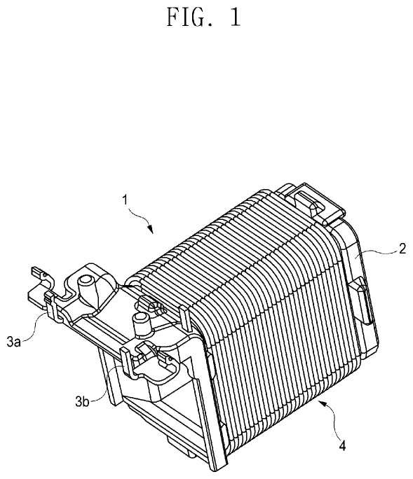

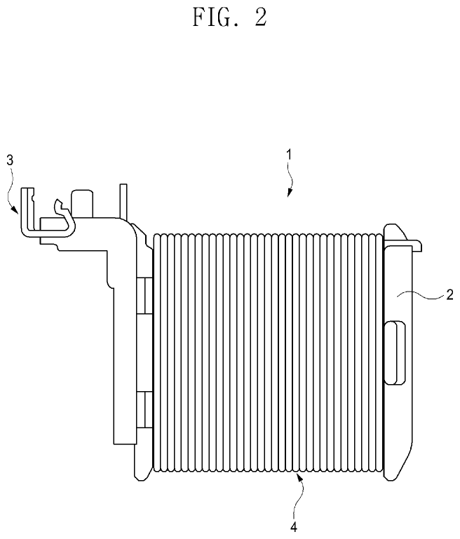

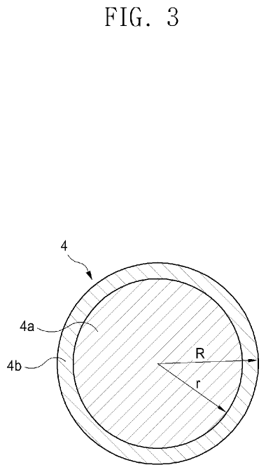

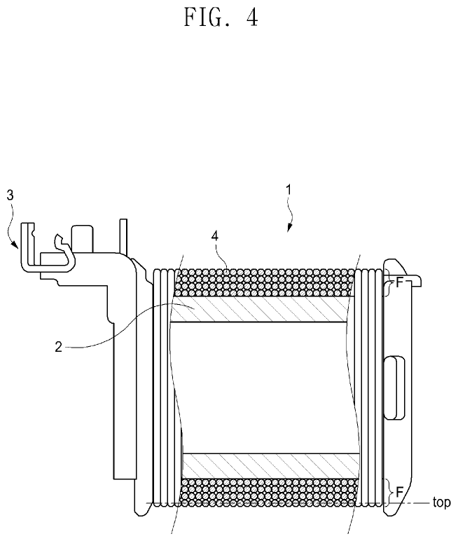

FIG. 1 is a perspective view of an ignition coil of the present invention, FIG. 2 is a front view of FIG. 1, FIG. 3 is a cross-sectional view illustrating a wire of an ignition coil of the present invention, and FIG. 4 is a partial cross-sectional view of FIG. 2 for explaining a wire structure.

As illustrated in the drawings, an ignition coil 1 of the present invention comprises a spool 2 having a pipe shape, a wire 4 wound on an outer circumference of the spool 2, and a terminal 3 for connecting the wire 4 to a battery or a spark plug. That is, the wire 4 is wound on the spool 2 after one end thereof is welded to a first terminal 3a, and is mounted to the spool 2 as the other end thereof is welded to a second terminal 3b. In addition, the spool 2 and the wire 4 is constituted primarily and secondarily, and a primary wire is wound on a primary spool while a secondary wire is wound on a secondary spool. The output energy of the ignition coil is determined according to the winding ratio of the primary wire and the secondary wire.

The present invention relates to the wire 4 wound on the spool 2 and a winding structure of the wire 4 and may be applied to all of the primary wire, the secondary wire, and the winding structures thereof, Hereinafter, however, only the primary wire and the winding of the primary wire on the primary spool are described for convenience. As described below, with respect to a conventional 100% copper wire and a conventional winding structure, the effects of the secondary wire and the winding structure thereof follow the conventional structure, and specific numerical values improved by the present invention also correspond to only the primary wire and the winding structure thereof. Thus, when the secondary wire and the winding structure thereof are also improved by the features of the present invention, it is apparent that the effects may be more maximized.

The wire 4 is formed extending in one direction and is wound on the spool 2, and a central portion of a cross-section perpendicular to the direction of extension is formed of aluminum 4a, while an outer surface thereof is formed of copper 4b. That is, the shape of surrounding the copper 4b on a core of the aluminum 4a is formed to extend. In the drawing, the wire 4 (a diameter R) is illustrated such that the aluminum 4a is formed in a circular shape (a diameter r) while the copper 4b is formed having a certain thickness, but the aluminum 4a and the wire 4 do not need to be a perfect circle. The copper 4b is positioned outside the aluminum 4a by taking into consideration the weldability with the terminal 3, because the terminal 3 is generally formed of the copper 4b.

Here, the wire 4 is manufactured through dissimilar metal bonding, not by plating the aluminum 4a with the copper 4b. In other words, it is common in the plating that the thickness is merely several micrometers (μm) to several tens of micrometers, whereas the thickness of the copper 4b may be several tens of millimeters (mm) or greater depending on the thickness of the wire 4 in the present invention. In the dissimilar metal bonding, dissimilar metals are bonded at a certain pressure under a certain temperature, and the bonding may be performed as one metal infiltrates into the surface of the other metal in a bonding surface and is coupled thereto while forming an interface.

In the wire 4 of the present invention, a volume ratio of the aluminum 4a is greater than 80% and less than 95%. More preferably, the aluminum 4a may have a volume ratio greater than 80% and less than 90%. Also, a weight ratio of the aluminum 4a is greater than 55% and less than 85%.

The copper 4b has advantages of being high in conductivity and good in weldability with the terminal due to low resistance, but disadvantages of being low in thermal conductivity, heavy in weight (specific gravity 8.92), and expensive in costs. On the other hand, the aluminum 4a is relatively low in conductivity due to high resistance, but has advantages of being lightweight (2.72) compared to the copper 4b, inexpensive in costs, and high in thermal conductivity.

Thus, in the present invention made of the aluminum 4a and the copper 4b, a ratio between the aluminum 4a and the copper 4b is critical. When the volume ratio of the aluminum 4a is 80% or lower, the ratio of the copper 4b increases by that amount. When the ratio of the copper 4b increases, problems of the conventional copper 4b may be highlighted. That is, the effects of reducing weight and material costs may be somewhat lowered. Furthermore, the copper 4b is not good in heat-generating characteristics due to the low thermal conductivity, and thus there is a problem that the output energy is lowered for the same volume.

On the contrary, when the volume ratio of the aluminum 4a is 95% or higher, there is a problem that the conventional processes may not be used. More specifically, the strength becomes low due to flexible characteristics of the aluminum 4a, and there is a problem that the wire 4 is broken when the wire 4 is wound at the tension degree and speed of a conventional winding machine. Also, when the ratio of the aluminum 4a is increased, the resistance becomes high, and thus the line diameter has to be increased. However, since the size of the spool 2 is fixed, the ratio of the aluminum 4a may not be increased to 95% or higher in order to use the conventional spool 2 as it is. Consequently, the conventional components and processes may not be used as they are.

Meanwhile, the aluminum 4a and the copper 4b are different from each other not only in resistance but also in inductance. Thus, when the ratio between the aluminum 4a and the copper 4b is determined, the resistance and inductance has to be considered, and furthermore, the wire diameter (the line diameter) R also needs to be adjusted. The applicant developed a structure of the wire 4 of the ignition coil 1 which enables the conventional processes to be used as they are.

When having the volume ratio of 85% aluminum 4a and 15% copper 4b, the line diameter R is increased at the rate of 8 to 12% compared to when the wire 4 is constituted by the conventional 100% copper 4b. Thus, the cross-sectional area is increased by about 16 to 26%, and in this case, an experiment showed that output energy to the extent equivalent to the conventional wire 4 is obtained. Even though the resistance of the wire is increased, the inductance is also increased, and thus the output energy may be compensated. In this case, it is apparent that the conventional processes such as other components and facilities may be used as they are.

TABLE 1

Material properties of wire 4

| | 85% aluminum 4a, | |
|---|---|---|
| | 15% copper 4b | 100% copper 4b |
| Line diameter (mm) | 0.65 | 0.6 |
| Actually measured line | 0.7 | 0.63 |
| diameter (mm) | | |
| Wire weight (g) | 13.6 | 23.1 |
| Resistance (mΩ) | 610.4 | 465.2 |
| Inductance (μH) | 213 | 189 |

In the above table, the line diameter and properties of the wire are summarized by comparing a case in which the volume ratio of the aluminum 4a is 85% in 120 mJ of the output energy and a case in which the conventional 100% copper 4b is used. Here, the line diameters R are different from the actually measured line diameters because the thickness of an insulating cover of the wire 4 is added in the actually measured line diameter. The insulating cover is to prevent insulation breakdown of the wire 4 and is generally made of a polyimide material. Furthermore, the winding structure of the present invention will be described with reference to FIG. 4. The wire 4 of the present invention is wound on the spool 2 so as to form a plurality of winding layers F, and an uppermost layer top positioned on an outermost side among the plurality of winding layers F is formed having the same number of windings as a layer adjacent to the uppermost layer top. More preferably, the winding layers F are formed of at least three layers, and the numbers of windings are the same for each of the winding layers F. When 100% copper 4b is used in the wire 4, the heat-generating efficiency is increased by widening the surface because the heat-generating characteristics of the copper 4b is poor. That is, the number of windings on an upper layer among the winding layers F is made less than that on a lower layer, and thus the surface is widened. However, since the numbers of windings are the same for each of the winding layers F in the present invention, it does not need to consider the number of windings for each of the winding layers F, and thus more efficient winding operation may be performed. Consequently, in the present invention, the material of the wire 4 may be changed to include the aluminum 4a, the line diameter R may be widened, and the numbers of windings may be the same for each of the winding layers F.

When assuming that the spool 2 having the same size is used and comparing to the winding of the conventional wire 4, the line diameter R is increased, and the maximum number of windings on one winding layer F is reduced. However, the winding is possible, like on a lower layer, even in a region in which winding has not be performed because the number of windings on an upper layer among the conventional winding layers F is reduced. Thus, the total number of windings may be equal to or greater than the conventional one.

Referring to FIG. 4 again, when the wire 4 on an upper layer is wound in the present invention, the wire 4 is not wound between the wire 4 wound on the lower layer. Instead, winding is performed so that the centers of the wire 4 for each layer are aligned with each other. In the case, the entire volume of windings is increased compared to when the wire 4 is wound alternately, but the surface is widened. Thus, there is an effect of preventing the insulation breakdown and increasing the heat-generating efficiency.

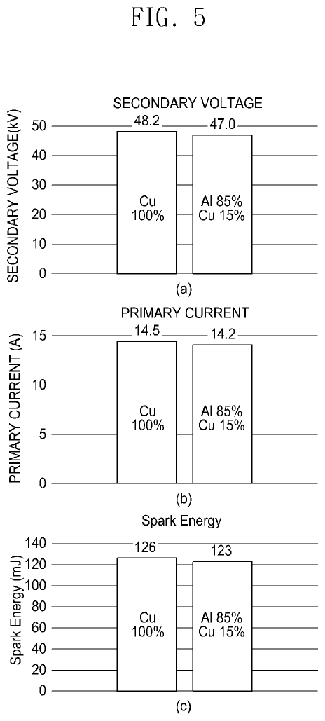

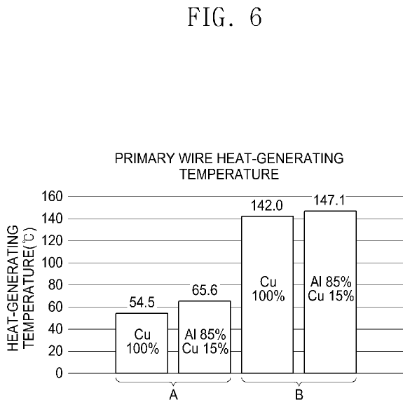

FIG. 5 is a graph in which characteristics relating to energy are compared between the conventional art and the present invention, and FIG. 6 is a graph in which heat-generating characteristics are compared between the conventional art and the present invention. In the graphs, a case in which the wire 4 of the conventional 100% copper 4b is used and a case in which the wire 4 including 85% aluminum 4a is used are compared to each other. The experiment is performed on the line diameters described in the above table, and the results are obtained by applying the present invention only to the primary coil.

In FIG. 5, secondary voltage ((a) of FIG. 5), primary current ((b) of FIG. 5), and spark energy ((c) of FIG. 5) are compared. The graph shows that the wire 4 of the conventional 100% copper 4b is slightly superior to the present invention, but this level of difference may be evaluated to exhibit approximately the same performance in the ignition coil 1.

In FIG. 6, heat-generating temperatures of the primary wire 4 are measured at room temperature (25° C.) environment A and 120° C. environment B, and 120° C. herein is a heat-generating temperature when an actual engine is subjected to maximum load. Referring to the drawing, it may be found that the present invention generates heat at a higher temperature compared to the wire 4 of the 100% copper 4b. Through this, it may be found that the heat-generating characteristics of the present invention is excellent. That is, this means that the limit value for increasing the number of windings is increased, and accordingly, the inductance is increased. Thus, the output energy may be increased. Furthermore, durability of the ignition coil 1 and peripheral components may be enhanced.

The technical ideas of the present invention have been described merely for illustrative purposes, and those skilled in the art will appreciate that various changes and modifications are possible without departing from the essential features of the present invention. The scope of the present inventions should be interpreted by the appended claims, and all technical ideas within their equivalents should be interpreted to be included in the scope of right in the present invention.

1. An ignition coil comprising:
a spool having a pipe shape; and
a wire wound on an outer circumference of the spool,
wherein the wire is formed extending in one direction, and a central portion of a cross-section perpendicular to the direction of extension is formed of aluminum, while an outer surface thereof is formed of copper.

2. The ignition coil of claim 1, wherein a volume ratio of the aluminum in the wire is greater than 80% and less than 95%.

3. The ignition coil of claim 1, wherein a weight ratio of the aluminum in the wire is greater than 55% and less than 85%.

4. The ignition coil of claim 1, wherein the wire is wound on the spool so as to form a plurality of winding layers, and
an uppermost layer positioned on an outermost side among the plurality of winding layers is formed having the same number of windings as a layer adjacent to the uppermost layer.

5. The ignition coil of claim 4, wherein the winding layers are formed of at least three layers, and
the numbers of windings are the same for each of the winding layers.

6. The ignition coil of claim 2, wherein the wire is wound on the spool so as to form a plurality of winding layers, and
an uppermost layer positioned on an outermost side among the plurality of winding layers is formed having the same number of windings as a layer adjacent to the uppermost layer.

7. The ignition coil of claim 3, wherein the wire is wound on the spool so as to form a plurality of winding layers, and
an uppermost layer positioned on an outermost side among the plurality of winding layers is formed having the same number of windings as a layer adjacent to the uppermost layer.
